(19) United States
(12) Patent Application Publication
(10) Pub. No.: US 2026/0039005 A1
(43) Pub. Date: Feb. 5, 2026

(54) ELECTRONIC COMPONENT

(71) Applicant: TDK Corporation, Tokyo (JP)

(72) Inventors: Yukio MITAKE, Tokyo (JP); Kohei YAMAGUCHI, Tokyo (JP)

(73) Assignee: TDK Corporation, Tokyo (JP)

(21) Appl. No.: 19/269,076

(22) Filed: Jul. 15, 2025

(30) Foreign Application Priority Data
Aug. 1, 2024 (JP) 2024-126070

(51) Int. Cl. H01P 5/18

(52) U.S. Cl. CPC H01P 5/18

(57) ABSTRACT

Provided is an electronic component including: an insulator; and a first terminal electrode, a second terminal electrode, a third terminal electrode, and a fourth terminal electrode disposed on a mounting surface of the insulator, in which a first line electrically connecting the third terminal electrode and the fourth terminal electrode and a second line electrically connecting the first terminal electrode and the second terminal electrode are configured in a first conductor layer and a second conductor layer, the second line includes a resistor provided on an end portion side connected to the second terminal electrode in the second line and a capacitor, the resistor and the capacitor are electrically connected in parallel, and the first line and the second line are magnetically coupled.

### CROSS-REFERENCE TO RELATED APPLICATION

This application is based upon and claims the benefit of priority from Japanese Patent Application No. 2024-126070, filed on Aug. 1, 2024, the entire contents of which are incorporated herein by reference.

### TECHNICAL FIELD

The present disclosure relates to an electronic component.

### BACKGROUND

WO 2018/079614 A discloses an electronic component including: a directional coupler including an input port, an output port, a coupling port, a main line having one end connected to the input port and the other end connected to the output port, and a sub-line electromagnetically coupled to the main line and having one end connected to the coupling port; a first capacitor connected in parallel with the sub-line; a second capacitor connecting the other end of the sub-line and a ground; an impedance element (resistance element) connecting the other end of the sub-line and the ground and having an impedance less than a normalized impedance at a predetermined frequency; a matching circuit connected between the one end of the sub-line and the coupling port and matching the impedance of the coupling port to the normalized impedance at the predetermined frequency; and a multilayer substrate configured by stacking a plurality of insulator layers and incorporating the directional coupler. In the electronic component described in WO 2018/079614 A, the impedance element is disposed on the multilayer substrate.

### SUMMARY

An object of one aspect of the present disclosure is to provide an electronic component capable of adjusting isolation while securing magnetic coupling.

(1) An electronic component according to one aspect of the present disclosure is an electronic component including: an element body formed by stacking a plurality of insulator layers and a plurality of conductor layers; and an input electrode, an output electrode, a detection electrode, and a ground electrode disposed on a mounting surface of the element body, in which the plurality of conductor layers include a first conductor layer and a second conductor layer, a first line electrically connecting the input electrode and the output electrode and a second line electrically connecting the detection electrode and the ground electrode are configured in the first conductor layer and the second conductor layer, the second line includes a resistor provided on an end portion side connected to the ground electrode in the second line and a capacitor, the resistor and the capacitor are electrically connected in parallel, and the first line and the second line are magnetically coupled.

In the electronic component according to one aspect of the present disclosure, the first line and the second line are magnetically coupled. As a result, magnetic coupling can be secured in the electronic component. In the electronic component, in a second line, a resistor (termination resistor) provided on the end portion side connected to the ground electrode in the second line, and a capacitor are provided. The resistor and the capacitor are electrically connected in parallel in the second line. As described above, in the electronic component, an attenuation pole can be formed in a relationship (graph) between a frequency and isolation by electrically connecting the resistor and the capacitor in parallel in the second line. Thus, it is possible to adjust isolation in the electronic component. Therefore, in the electronic component, it is possible to balance (adjust) magnetic coupling and isolation.

(2) In the electronic component according to (1), the first line and the second line may have portions extending side by side when viewed from a stacking direction of the element body, and may be magnetically coupled at the portions. In this configuration, it is possible to secure magnetic coupling between the first line and the second line.

(3) In the electronic component according to (2), the first line and the second line may not overlap each other when viewed from the stacking direction. In this configuration, it is possible to reduce a dimension of the element body in the stacking direction.

(4) In the electronic component according to (1) or (2), the first line and the second line may have portions overlapping each other when viewed from a stacking direction of the element body, and may be magnetically coupled at the portions. In this configuration, it is possible to secure magnetic coupling between the first line and the second line.

(5) In the electronic component according to (4), one of the first line and the second line may be wider than the other of the first line and the second line in the first line and the second line when viewed from the stacking direction. In this configuration, even when a deviation occurs in stacking between the first conductor layer and the second conductor layer, the first line and the second line overlap each other in the stacking direction. Therefore, in the electronic component, even when a deviation occurs in stacking between the first conductor layer and the second conductor layer, magnetic coupling between the first line and the second line can be secured.

(6) In the electronic component according to (5), one of the first line and the second line may be covered with the other of the first line and the second line in a portion where the first line and the second line overlap each other when viewed from the stacking direction. In this configuration, one of the first line and the second line does not protrude (project) from the other of the first line and the second line. Therefore, magnetic coupling between the first line and the second line can be secured more reliably.

(7) In the electronic component according to any one of (1) to (6), the resistor and the capacitor may be disposed at positions closer to the ground electrode than the detection electrode. Since the resistor is a termination resistor, the resistor is preferably disposed around the ground electrode. Therefore, by disposing the resistor and the capacitor electrically connected in parallel near the ground electrode, the resistor and the capacitor can be efficiently disposed in the element body.

(8) In the electronic component according to any one of (1) to (7), the resistor may be disposed on an inner side than the capacitor in the element body when viewed from the stacking direction. In this configuration, it is possible to suppress peeling of the resistor.

According to one aspect of the present disclosure, isolation can be adjusted while securing magnetic coupling.

### BRIEF DESCRIPTION OF THE DRAWINGS

FIG. 1 is a perspective diagram of an electronic component according to a first embodiment;

FIGS. 2A and 2B are diagrams illustrating a first conductor layer, a second conductor layer, and a third conductor layer included in the electronic component illustrated in FIG. 1;

FIGS. 3A, 3B, 3C, 3D, 3E, 3F, and 3G are diagrams illustrating conductor patterns included in the electronic component illustrated in FIG. 1;

FIG. 4 is a diagram illustrating a cross-sectional configuration of a part of the electronic component illustrated in FIG. 1;

FIG. 5 is a diagram illustrating a cross-sectional configuration of a part of an electronic component including a resistance pattern;

FIG. 6 is a diagram illustrating a cross-sectional configuration of a part of an electronic component including a conductor pattern;

FIG. 7 is a diagram illustrating a cross-sectional configuration of a part of an electronic component including conductor patterns;

FIG. 8 is a diagram illustrating conductor patterns included in the electronic component illustrated in FIG. 1;

FIG. 9 is an equivalent circuit diagram of the electronic component illustrated in FIG. 1;

FIGS. 10A and 10B are diagrams illustrating a first conductor layer and a second conductor layer included in an electronic component according to a second embodiment;

FIGS. 11A, 11B, 11C, 11D, 11E, 11F, and 11G are diagrams illustrating conductor patterns included in the electronic component;

FIG. 12 is a diagram illustrating a cross-sectional configuration of a part of an electronic component including conductor patterns;

FIG. 13 is a diagram illustrating conductor patterns included in the electronic component; and

FIG. 14 is an equivalent circuit diagram of the electronic component.

### DETAILED DESCRIPTION

Hereinafter, preferred embodiments of the present disclosure will be described in detail with reference to the accompanying drawings. Note that the same or corresponding elements in the description of the drawings are denoted by the same reference signs, and redundant description is omitted.

### First Embodiment

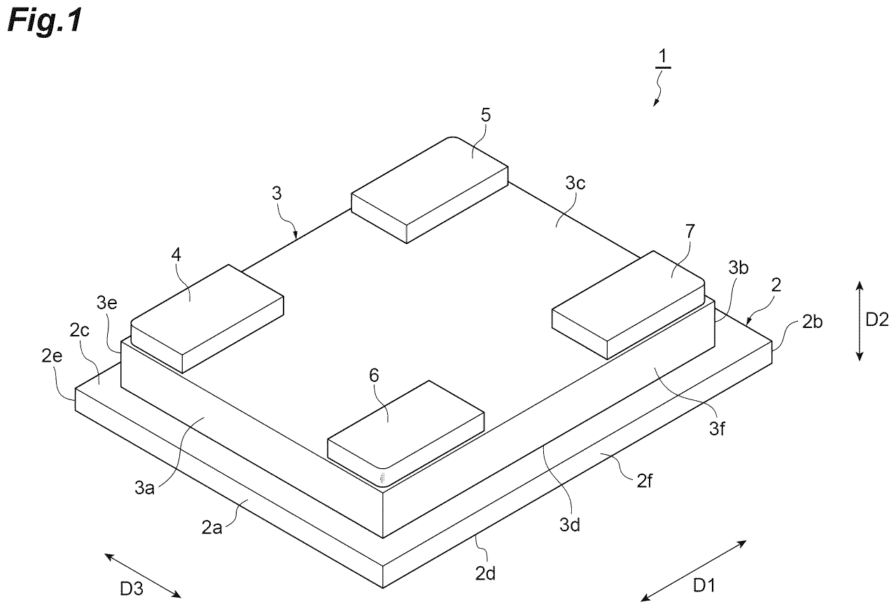

FIG. 1 is a perspective diagram of an electronic component according to a first embodiment. An electronic component 1 illustrated in FIG. 1 is a directional coupler. As illustrated in FIG. 1, the electronic component 1 includes a substrate 2, an insulator (element body) 3, a first terminal electrode 4, a second terminal electrode 5, a third terminal electrode 6, and a fourth terminal electrode 7.

The substrate 2 has, for example, a rectangular parallelepiped shape. The rectangular parallelepiped shape may include a rectangular parallelepiped shape in which corner portions and ridge line portions are chamfered, or a rectangular parallelepiped shape in which corner portions and ridge line portions are rounded. The substrate 2 has, as outer surfaces thereof, a pair of end surfaces 2a and 2b facing each other, a pair of main surfaces 2c and 2d facing each other, and a pair of side surfaces 2e and 2f facing each other.

A facing direction in which the pair of end surfaces 2a and 2b face each other is a first direction D1. A facing direction in which the pair of main surfaces 2c and 2d face each other is a second direction D2. A facing direction in which the pair of side surfaces 2e and 2f face each other is a third direction D3. In the present embodiment, the first direction D1 is a longitudinal direction of the substrate 2. The second direction D2 is a height direction of the substrate 2, and is orthogonal to the first direction D1. The third direction D3 is a width direction of the substrate 2, and is orthogonal to the first direction D1 and the second direction D2. Viewing from the second direction D2 corresponds to a plan view.

The pair of end surfaces 2a and 2b extend in the second direction D2 to connect the pair of main surfaces 2c and 2d. The pair of end surfaces 2a and 2b also extend in the third direction D3. The pair of side surfaces 2e and 2f extend in the second direction D2 to connect the pair of main surfaces 2c and 2d. The pair of side surfaces 2e and 2f also extend in the first direction D1. A dimension of the substrate 2 in the first direction D1 can be, for example, 0.65 mm. A dimension of the substrate 2 in the third direction D3 can be, for example, 0.5 mm.

The substrate 2 can be formed of a material that is chemically and thermally stable, generates less stress, and can maintain surface smoothness. The material is not particularly limited, but silicon single crystal, alumina, sapphire, aluminum nitride, MgO single crystal, SrTiO₃ single crystal, surface silicon oxide, glass, quartz, ferrite, and the like can be used.

The insulator 3 has a rectangular parallelepiped shape. The insulator 3 has, as the outer surfaces thereof, a pair of end surfaces 3a and 3b facing each other, a pair of main surfaces 3c and 3d facing each other, and a pair of side surfaces 3e and 3f facing each other. The pair of end surfaces 3a and 3b face each other in the first direction D1. The pair of main surfaces 3c and 3d face each other in the second direction D2. The pair of side surfaces 3e and 3f face each other in the third direction D3.

The pair of end surfaces 3a and 3b extend in the second direction D2 to connect the pair of main surfaces 3c and 3d. The pair of end surfaces 3a and 3b also extend in the third direction D3. The pair of side surfaces 3e and 3f extend in the second direction D2 to connect the pair of main surfaces 3c and 3d. The pair of side surfaces 3e and 3f also extend in the first direction D1. In the present embodiment, a dimension of the insulator 3 in the first direction D1 is smaller than the dimension of the substrate 2 in the first direction D1. A dimension of the insulator 3 in the third direction D3 is smaller than the dimension of the substrate 2 in the third direction D3. The dimension of the insulator 3 in the first direction D1 may be equal to the dimension of the substrate 2 in the first direction D1, or the dimension of the insulator 3 in the third direction D3 may be equal to the dimension of the substrate 2 in the third direction D3.

In the present embodiment, “equal” may mean not only “equal” but also a value including a minute difference, a manufacturing error, or the like in a preset range. For example, in a case where a plurality of values are included within a range of ±5% of an average value of the plurality of values, the plurality of values are defined to be equal.

The insulator 3 is formed by stacking a plurality of insulator layers. The insulator layers may be made of an organic insulating material such as polyimide. The insulator layers are stacked in the second direction D2. That is, the second direction D2 is a stacking direction. In the actual insulator 3, the plurality of insulator layers are integrated to such an extent that boundaries between the layers cannot be visually recognized.

The substrate 2 and the insulator 3 are integrally provided. The substrate 2 and the insulator 3 are disposed such that the main surface 2c and the main surface 2d face each other. A planarization layer 8 is disposed between the substrate 2 and the insulator 3. The planarization layer 8 is disposed between the main surface 2c of the substrate 2 and the main surface 3d of the insulator 3. As the planarization layer 8, silicon nitride, alumina, silicon oxide, or the like can be used.

The first terminal electrode 4, the second terminal electrode 5, the third terminal electrode 6, and the fourth terminal electrode 7 are disposed on the main surface (mounting surface) 3c of the insulator 3. The first terminal electrode 4 can be a coupling electrode (detection electrode). The second terminal electrode 5 can be a ground electrode. The third terminal electrode 6 can be an input electrode of a signal. The fourth terminal electrode 7 can be an output electrode of a signal.

The first terminal electrode 4, the second terminal electrode 5, the third terminal electrode 6, and the fourth terminal electrode 7 have a substantially rectangular shape in plan view. The rectangular shape may include a shape in which corner portions and ridge portions are chamfered and a shape in which corner portions and ridge portions are rounded. In the present embodiment, the first terminal electrode 4, the second terminal electrode 5, the third terminal electrode 6, and the fourth terminal electrode 7 have a rectangular shape in which one corner portion is rounded in plan view. The first terminal electrode 4, the second terminal electrode 5, the third terminal electrode 6, and the fourth terminal electrode 7 are disposed at corner portions of the insulator 3, respectively.

The first terminal electrode 4 is disposed at a position close to the end surface 3a and close to the side surface 3e. The second terminal electrode 5 is disposed at a position close to the end surface 3b and close to the side surface 3e. The third terminal electrode 6 is disposed at a position close to the end surface 3a and close to the side surface 3f. The fourth terminal electrode 7 is disposed at a position close to the end surface 3b and close to the side surface 3f.

The first terminal electrode 4 and the second terminal electrode 5 are disposed at an interval in the first direction D1. The third terminal electrode 6 and the fourth terminal electrode 7 are disposed at an interval in the first direction D1. The first terminal electrode 4 and the third terminal electrode 6 are disposed at an interval in the third direction D3. The second terminal electrode 5 and the fourth terminal electrode 7 are disposed at an interval in the third direction D3. The interval (distance) between the electrodes may be appropriately set according to the specifications required for the electronic component 1.

The first terminal electrode 4, the second terminal electrode 5, the third terminal electrode 6, and the fourth terminal electrode 7 can be formed of an appropriate conductor (for example, gold, nickel, copper, silver, or the like).

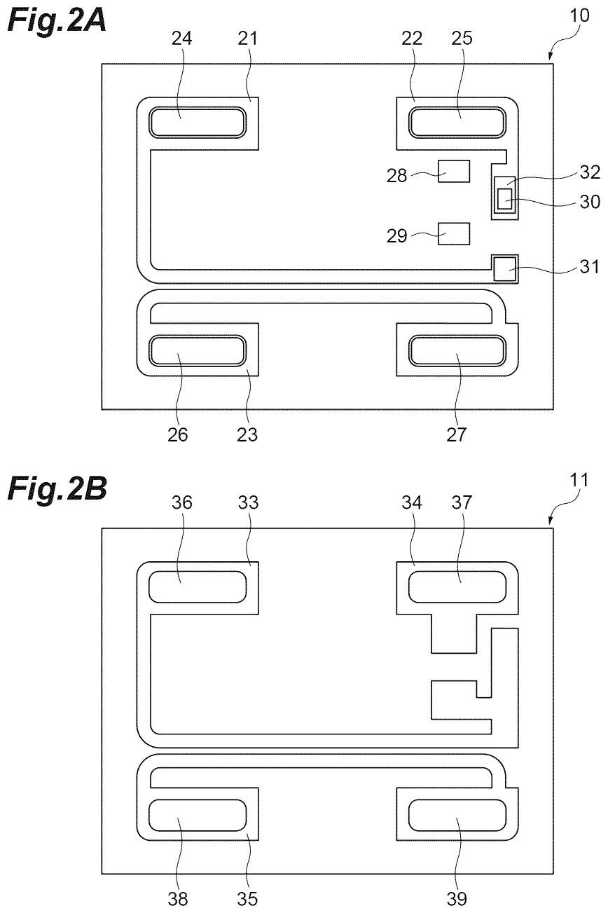

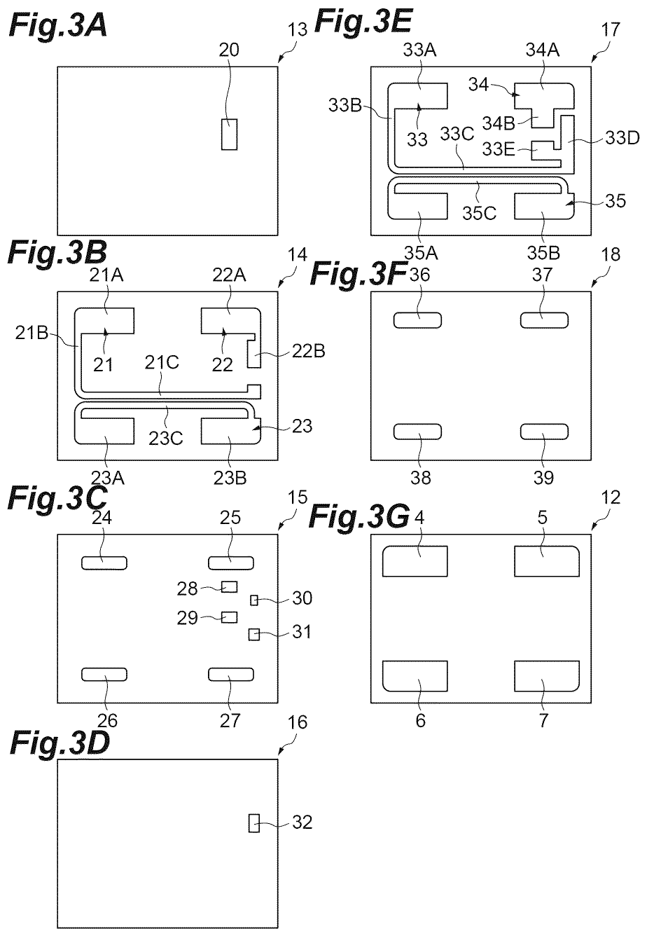

FIGS. 2A and 2B are diagrams illustrating a first conductor layer, a second conductor layer, and a third conductor layer included in the electronic component 1 illustrated in FIG. 1. FIGS. 3A, 3B, 3C, 3D, 3E, 3F, and 3G are diagrams illustrating conductor patterns included in the electronic component 1 illustrated in FIG. 1.

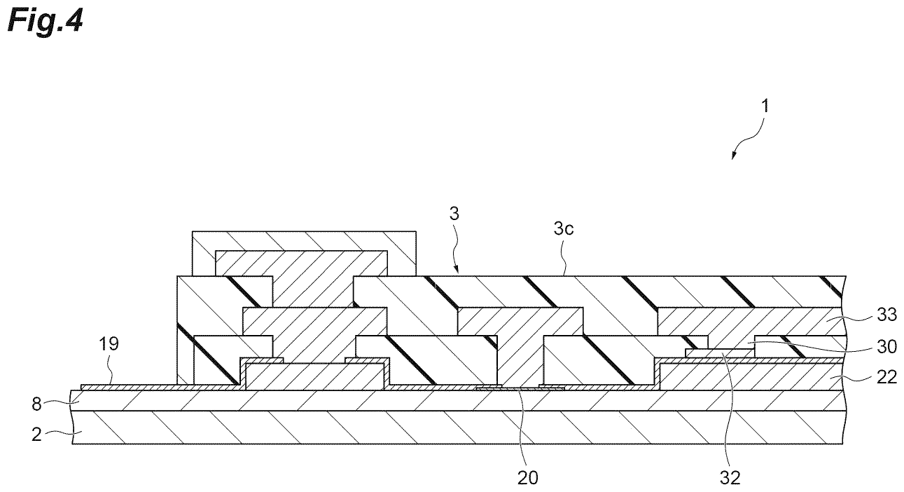

As illustrated in FIGS. 2A and 2B, the electronic component 1 includes a first conductor layer 10, a second conductor layer 11, and a third conductor layer 12. The first conductor layer 10, the second conductor layer 11, and the third conductor layer 12 are disposed in different layers in the second direction D2. In the electronic component 1, the first conductor layer 10, the second conductor layer 11, and the third conductor layer 12 are disposed in this order from the substrate 2 side (the main surface 3d side of the insulator 3). Specifically, as illustrated in FIG. 4, the planarization layer 8 is disposed between the main surface 2c of the substrate 2 and the main surface 3d of the insulator 3. The first conductor layer 10 is disposed on the planarization layer 8. The planarization layer 8 can be formed of, for example, alumina, silicon oxide, or the like.

As illustrated in FIGS. 3A, 3B, 3C, 3D, 3E, 3F, and 3G, the first conductor layer 10 includes a conductor layer 13, a conductor layer 14, a conductor layer 15, and a conductor layer 16. The second conductor layer 11 includes a conductor layer 17 and a conductor layer 18.

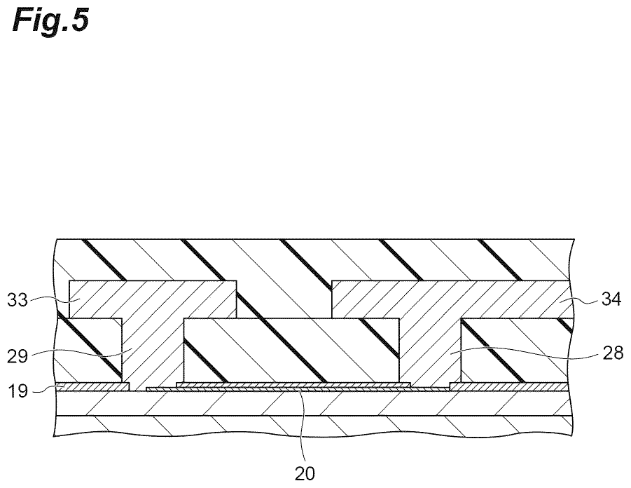

As illustrated in FIG. 3A, the conductor layer 13 includes a resistance pattern 20. The resistance pattern 20 has, for example, a rectangular shape. FIG. 5 is a diagram illustrating a cross-sectional configuration of a part of the electronic component 1 including the resistance pattern 20. As illustrated in FIG. 5, the resistance pattern 20 is disposed across a conductor pattern 28 and a conductor pattern 29 of the conductor layer 15. The resistance pattern 20 electrically connects the conductor pattern 28 and the conductor pattern 29. The resistance pattern 20 can be formed of an appropriate conductor (for example, nickel, chromium, aluminum, or the like).

As illustrated in FIG. 3B, the conductor layer 14 includes a conductor pattern 21, a conductor pattern 22, and a conductor pattern 23. The conductor pattern 21, the conductor pattern 22, and the conductor pattern 23 can be formed of an appropriate conductor (for example, copper or the like).

The conductor pattern 21 includes a first pattern portion 21A, a second pattern portion 21B, and a third pattern portion 21C. The first pattern portion 21A, the second pattern portion 21B, and the third pattern portion 21C may be integrally formed. The first pattern portion 21A is disposed at a position close to the end surface 3a and close to the side surface 3e. The second pattern portion 21B extends linearly along the third direction D3. One end of the second pattern portion 21B is connected to the first pattern portion 21A. The other end of the second pattern portion 21B is connected to the third pattern portion 21C. The third pattern portion 21C extends linearly along the first direction D1. One end of the third pattern portion 21C is connected to the second pattern portion 21B.

The conductor pattern 22 includes a first pattern portion 22A and a second pattern portion 22B. The first pattern portion 22A and the second pattern portion 22B may be integrally formed. The first pattern portion 22A is disposed at a position close to the end surface 3b and close to the side surface 3e. The second pattern portion 22B is disposed at a position close to the end surface 3b.

The conductor pattern 23 includes a first pattern portion 23A, a second pattern portion 23B, and a third pattern portion 23C. The first pattern portion 23A, the second pattern portion 23B, and the third pattern portion 23C may be integrally formed. The first pattern portion 23A is disposed at a position close to the end surface 3a and close to the side surface 3f. The second pattern portion 23B is disposed at a position close to the end surface 3b and close to the side surface 3f.

The third pattern portion 23C extends linearly along the first direction D1. One end of the third pattern portion 23C is connected to the first pattern portion 23A. The other end of the third pattern portion 23C is connected to the second pattern portion 23B. The third pattern portion 23C is parallel to the third pattern portion 21C of the conductor pattern 21. The third pattern portion 23C is disposed at an interval from the third pattern portion 21C of the conductor pattern 21 in the third direction D3. The interval may be, for example, 10 μm.

As illustrated in FIG. 3C, the conductor layer 15 includes a conductor pattern 24, a conductor pattern 25, a conductor pattern 26, a conductor pattern 27, a conductor pattern 28, a conductor pattern 29, a conductor pattern 30, and a conductor pattern 31. The conductor pattern 24, the conductor pattern 25, the conductor pattern 26, the conductor pattern 27, the conductor pattern 28, the conductor pattern 29, the conductor pattern 30, and the conductor pattern 31 can be formed of an appropriate conductor (for example, copper or the like).

The conductor pattern 24 is disposed at a position close to the end surface 3a and close to the side surface 3e. The conductor pattern 24 electrically connects the conductor pattern 21 of the conductor layer 14 and a conductor pattern 33 (see FIG. 3E) of the conductor layer 17 (see FIG. 3E). The conductor pattern 25 is disposed at a position close to the end surface 3b and close to the side surface 3e. The conductor pattern 25 electrically connects the conductor pattern 22 of the conductor layer 14 and a conductor pattern 34 (see FIG. 3E) of the conductor layer 17.

The conductor pattern 26 is disposed at a position close to the end surface 3a and close to the side surface 3f. The conductor pattern 26 electrically connects the conductor pattern 23 of the conductor layer 14 and a conductor pattern 35 (see FIG. 3E) of the conductor layer 17. The conductor pattern 27 is disposed at a position close to the end surface 3b and close to the side surface 3f. The conductor pattern 27 electrically connects the conductor pattern 23 of the conductor layer 14 and the conductor pattern 35 (see FIG. 3E) of the conductor layer 17.

The conductor pattern 28 electrically connects the resistance pattern 20 of the conductor layer 13 and the conductor pattern 34 (see FIG. 3E) of the conductor layer 17. The conductor pattern 29 electrically connects the resistance pattern 20 of the conductor layer 13 and the conductor pattern 33 (see FIG. 3E) of the conductor layer 17. The conductor pattern 29 is disposed at a position facing the conductor pattern 28 in the third direction D3 in plan view.

The conductor pattern 30 electrically connects the conductor pattern 22 of the conductor layer 14 and the conductor pattern 32 (see FIG. 3D) of the conductor layer 16. The conductor pattern 31 electrically connects the conductor pattern 21 of the conductor layer 14 and the conductor pattern 33 (see FIG. 3E) of the conductor layer 17.

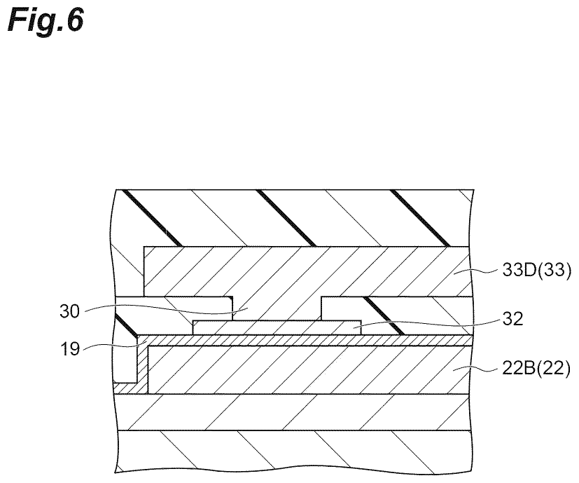

As illustrated in FIG. 3D, the conductor layer 16 includes the conductor pattern 32. The conductor pattern 32 can be formed of an appropriate conductor (for example, copper or the like). FIG. 6 is a diagram illustrating a cross-sectional configuration of a part of the electronic component 1 including the conductor pattern 32. As illustrated in FIG. 6, the conductor pattern 32 is a conductor (intermediate conductor) that is stacked on the conductor pattern 22 formed in the conductor layer 14 with a dielectric film 19 interposed therebetween and constitutes an upper electrode of a capacitor C described later. The dielectric film 19 is, for example, silicon nitride.

As illustrated in FIG. 3E, the conductor layer 17 includes the conductor pattern 33, the conductor pattern 34, and the conductor pattern 35. The conductor pattern 33, the conductor pattern 34, and the conductor pattern 35 can be formed of an appropriate conductor (for example, copper or the like).

The conductor pattern 33 includes a first pattern portion 33A, a second pattern portion 33B, a third pattern portion 33C, a fourth pattern portion 33D, and a fifth pattern portion 33E. The first pattern portion 33A, the second pattern portion 33B, the third pattern portion 33C, the fourth pattern portion 33D, and the fifth pattern portion 33E may be integrally formed.

The first pattern portion 33A is disposed at a position close to the end surface 3a and close to the side surface 3e. The second pattern portion 33B extends linearly along the third direction D3. One end of the second pattern portion 33B is connected to the first pattern portion 33A. The other end of the second pattern portion 33B is connected to the third pattern portion 33C. The third pattern portion 33C extends linearly along the first direction D1. One end of the third pattern portion 33C is connected to the second pattern portion 33B. The other end of the third pattern portion 33C is connected to the fourth pattern portion 33D. The fourth pattern portion 33D extends linearly along the third direction D3. One end of the fourth pattern portion 33D is connected to the third pattern portion 33C. The fifth pattern portion 33E is connected to the fourth pattern portion 33D.

The conductor pattern 34 includes a first pattern portion 34A and a second pattern portion 34B. The first pattern portion 34A and the second pattern portion 34B may be integrally formed. The first pattern portion 34A is disposed at a position close to the end surface 3b and close to the side surface 3e. The second pattern portion 34B is disposed at a position facing the fifth pattern portion 33E of the conductor pattern 33 in the third direction D3 in plan view.

The conductor pattern 35 has the same shape as the conductor pattern 23 of the conductor layer 14. The conductor pattern 35 includes a first pattern portion 35A, a second pattern portion 35B, and a third pattern portion 35C. The first pattern portion 35A, the second pattern portion 35B, and the third pattern portion 35C may be integrally formed. The first pattern portion 35A is disposed at a position close to the end surface 3a and close to the side surface 3f. The second pattern portion 35B is disposed at a position close to the end surface 3b and close to the side surface 3f.

The third pattern portion 35C extends linearly along the first direction D1. One end of the third pattern portion 35C is connected to the first pattern portion 35A. The other end of the third pattern portion 35C is connected to the second pattern portion 35B. The third pattern portion 35C is parallel to the third pattern portion 33C of the conductor pattern 33. The third pattern portion 35C is disposed at an interval from the third pattern portion 33C of the conductor pattern 33 in the third direction D3. The interval may be, for example, 10 μm.

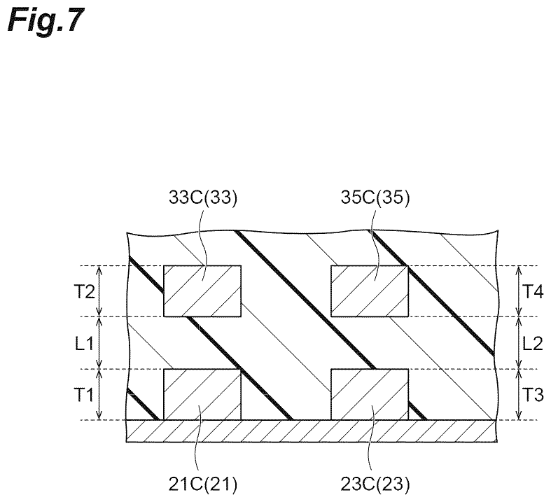

FIG. 7 is a diagram illustrating a cross-sectional configuration of a part of the electronic component 1 including conductor patterns. As illustrated in FIG. 7, the third pattern portion 21C of the conductor pattern 21 and the third pattern portion 33C of the conductor pattern 33 are disposed at positions facing each other in the second direction D2. That is, the third pattern portion 21C of the conductor pattern 21 and the third pattern portion 33C of the conductor pattern 33 are disposed at positions overlapping each other in plan view. A distance L1 between the third pattern portion 21C of the conductor pattern 21 and the third pattern portion 33C of the conductor pattern 33 in the second direction D2 can be, for example, 5 μm. A thickness T1 of the third pattern portion 21C of the conductor pattern 21 and a thickness T2 of the third pattern portion 33C of the conductor pattern 33 can be, for example, 5 μm. The distance L1 and the thicknesses T1 and T2 can be the same (L1=T1, T2).

The third pattern portion 23C of the conductor pattern 23 and the third pattern portion 35C of the conductor pattern 35 are disposed at positions facing each other in the second direction D2. That is, the third pattern portion 23C of the conductor pattern 23 and the third pattern portion 35C of the conductor pattern 35 are disposed at positions overlapping each other in plan view. A distance L2 between the third pattern portion 23C of the conductor pattern 23 and the third pattern portion 35C of the conductor pattern 35 in the second direction D2 can be, for example, 5 μm. A thickness T3 of the third pattern portion 23C of the conductor pattern 23 and a thickness T4 of the third pattern portion 35C of the conductor pattern 35 can be, for example, 5 μm. The distance L2 and the thicknesses T3 and T4 can be the same (L2=T3, T4).

As illustrated in FIG. 3F, the conductor layer 18 includes a conductor pattern 36, a conductor pattern 37, a conductor pattern 38, and a conductor pattern 39. The conductor pattern 36, the conductor pattern 37, the conductor pattern 38, and the conductor pattern 39 can be formed of an appropriate conductor (for example, copper or the like).

The conductor pattern 36 is disposed at a position close to the end surface 3a and close to the side surface 3e. The conductor pattern 36 electrically connects the conductor pattern 33 of the conductor layer 17 and a first terminal electrode 4 of the third conductor layer 12 (see FIG. 3G). The conductor pattern 37 is disposed at a position close to the end surface 3b and close to the side surface 3e. The conductor pattern 37 electrically connects the conductor pattern 34 of the conductor layer 17 and a second terminal electrode 5 (see FIG. 3G) of the third conductor layer 12.

The conductor pattern 38 is disposed at a position close to the end surface 3a and close to the side surface 3f. The conductor pattern 38 electrically connects the conductor pattern 35 of the conductor layer 17 and a third terminal electrode 6 (see FIG. 3G) of the third conductor layer 12. The conductor pattern 39 is disposed at a position close to the end surface 3b and close to the side surface 3f. The conductor pattern 39 electrically connects the conductor pattern 35 of the conductor layer 17 and a fourth terminal electrode 7 (see FIG. 3G) of the third conductor layer 12.

As illustrated in FIG. 3G, the third conductor layer 12 includes the first terminal electrode 4, the second terminal electrode 5, the third terminal electrode 6, and the fourth terminal electrode 7. The third conductor layer 12 is a terminal layer.

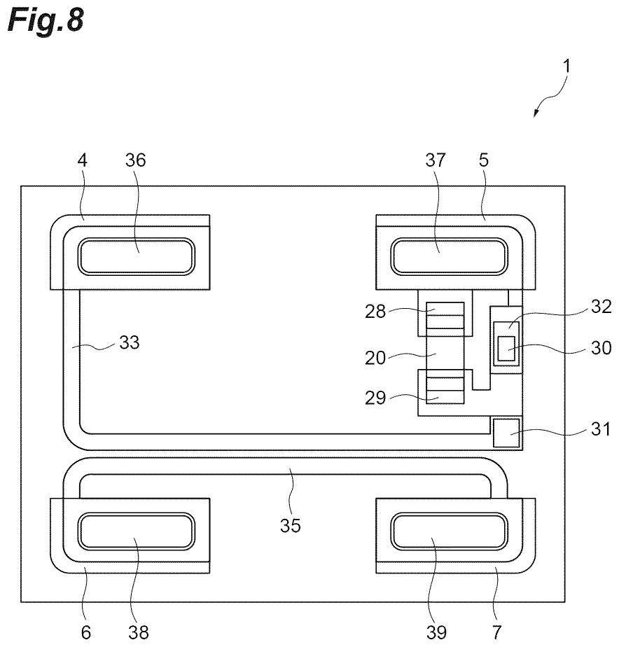

FIG. 8 is a diagram illustrating conductor patterns included in the electronic component 1 illustrated in FIG. 1. As illustrated in FIG. 8, the resistance pattern 20 and the capacitor pattern (the second pattern portion 22B of the conductor pattern 22, and the conductor pattern 32) are disposed at positions close to the second terminal electrode 5 (ground electrode). The resistance pattern 20 is disposed at a position on the inner side (closer to the center) of the insulator 3 than the capacitor pattern in plan view. That is, the resistance pattern 20 is disposed at a position farther from the end surface 3b of the insulator 3 than the capacitor pattern in plan view.

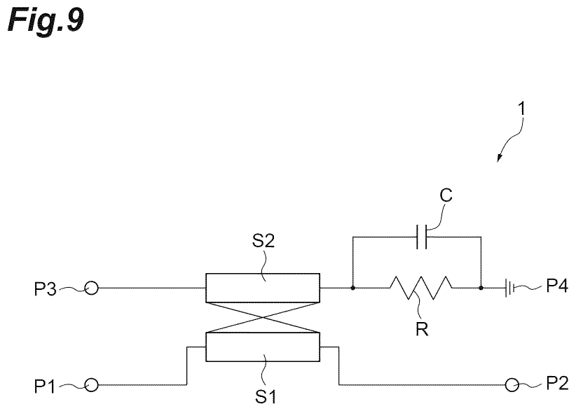

FIG. 9 is an equivalent circuit diagram of the electronic component 1 illustrated in FIG. 1. As illustrated in FIG. 9, the electronic component 1 includes an input port P1, an output port P2, a coupling port P3, a ground port P4, a first line S1, and a second line S2.

The input port P1 is constituted by the third terminal electrode 6. The output port P2 is constituted by the fourth terminal electrode 7. The coupling port P3 is constituted by the first terminal electrode 4. The ground port P4 is constituted by the second terminal electrode 5.

The first line S1 connects the input port P1 and the output port P2. The first line S1 is constituted by the third pattern portion 23C of the conductor pattern 23 and the third pattern portion 35C of the conductor pattern 35. The second line S2 electrically connects the coupling port P3 and the ground port P4. The second line S2 is constituted by the third pattern portion 21C of the conductor pattern 21 and the third pattern portion 33C of the conductor pattern 33. The second line S2 includes a resistor R and a capacitor C.

The first line S1 and the second line S2 are electromagnetically coupled. Specifically, the third pattern portion 21C of the conductor pattern 21 and the third pattern portion 23C of the conductor pattern 23 are electromagnetically coupled. The third pattern portion 33C of the conductor pattern 33 and the third pattern portion 35C of the conductor pattern 35 are electromagnetically coupled.

The resistor R is constituted by the resistance pattern 20. The resistor R is a termination resistor. The resistor R is connected between the second line S2 and the ground port P4. The resistor R is, for example, smaller than 50Ω. The capacitor C is constituted by the conductor pattern 32 and the fourth pattern portion 33D of the conductor pattern 33. The capacitor C is connected between the second line S2 and the ground port P4. The resistor R and the capacitor C are electrically connected in parallel.

As described above, in the electronic component 1 according to the present embodiment, the first line S1 and the second line S2 are magnetically coupled. As a result, magnetic coupling can be secured in the electronic component 1. In the electronic component 1, in the second line S2, the resistor R (termination resistor) provided on the end portion side connected to the second terminal electrode 5 (ground electrode) in the second line S2 and the capacitor C are provided. The resistor R and the capacitor C are electrically connected in parallel in the second line S2. As described above, in the electronic component 1, an attenuation pole can be formed in a relationship (graph) between a frequency and isolation by electrically connecting the resistor R and the capacitor C in parallel in the second line S2. Thus, it is possible to adjust isolation in the electronic component 1. Therefore, in the electronic component 1, it is possible to balance (adjust) magnetic coupling and isolation.

In the electronic component 1 according to the present embodiment, the first line S1 and the second line S2 have portions (the third pattern portion 21C and the third pattern portion 23C, and the third pattern portion 33C and the third pattern portion 35C) extending side by side when viewed from the stacking direction (second direction D2) of the insulator 3, and are magnetically coupled at the portions. In this configuration, it is possible to secure magnetic coupling between the first line S1 and the second line S2.

In the electronic component 1 according to the present embodiment, the resistor R and the capacitor C are disposed at positions closer to the second terminal electrode 5 (ground electrode) than the first terminal electrode 4 (detection electrode). Since the resistor R is a termination resistor, the resistor R is preferably disposed around the second terminal electrode 5. Therefore, by disposing the resistor R and the capacitor C electrically connected in parallel near the second terminal electrode 5, the resistor R and the capacitor C can be efficiently disposed in the insulator 3.

In the electronic component 1 according to the present embodiment, the resistor R is disposed on the inner side than the capacitor C in the insulator 3 when viewed from the second direction D2 (plan view). In this configuration, the resistor R is disposed at a position away from the end surfaces 3a and 3b and the side surfaces 3e and 3f of the insulator 3. Therefore, in the electronic component 1, it is possible to suppress peeling of the resistor R.

### Second Embodiment

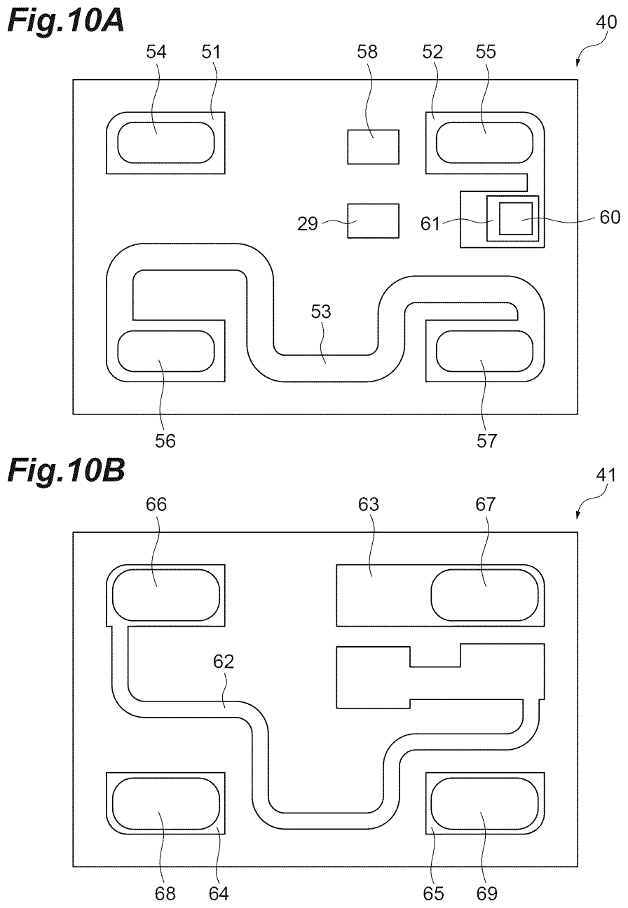

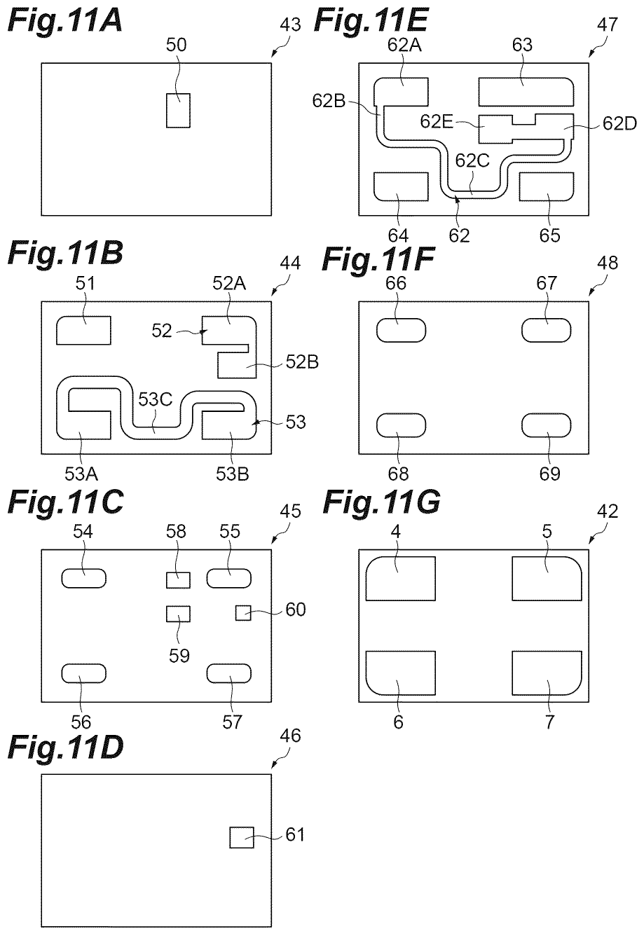

Next, a second embodiment will be described. FIGS. 10A and 10B are diagrams illustrating a first conductor layer and a second conductor layer included in an electronic component according to a second embodiment. As illustrated in FIGS. 10A and 10B, an electronic component 1A according to the second embodiment includes a first conductor layer 40, a second conductor layer 41, and a third conductor layer 42 (see FIG. 11G). In the electronic component 1A, the dimension of the substrate 2 in the first direction D1 can be, for example, 0.47 mm. The dimension of the substrate 2 in the third direction D3 can be, for example, 0.32 mm.

The first conductor layer 40, the second conductor layer 41, and the third conductor layer 42 are disposed in different layers in the second direction D2. In the electronic component 1A, the first conductor layer 40, the second conductor layer 41, and the third conductor layer 42 are disposed in this order from the substrate 2 side (the main surface 3d side of the insulator 3).

FIGS. 11A, 11B, 11C, 11D, 11E, 11F, and 11G are diagrams illustrating conductor patterns included in the electronic component 1A. As illustrated in FIGS. 11A, 11B, 11C, 11D, 11E, 11F, and 11G, the first conductor layer 40 includes a conductor layer 43, a conductor layer 44, a conductor layer 45, and a conductor layer 46. The second conductor layer 41 includes a conductor layer 47 and a conductor layer 48.

As illustrated in FIG. 11A, the conductor layer 43 includes a resistance pattern 50. The resistance pattern 50 has, for example, a rectangular shape. The resistance pattern 50 is disposed across a conductor pattern 58 and a conductor pattern 59 of the conductor layer 45. The resistance pattern 50 electrically connects the conductor pattern 58 and the conductor pattern 59. The resistance pattern 50 can be formed of an appropriate conductor (for example, nickel, chromium, aluminum, and the like).

As illustrated in FIG. 11B, the conductor layer 44 includes a conductor pattern 51, a conductor pattern 52, and a conductor pattern 53. The conductor pattern 51, the conductor pattern 52, and the conductor pattern 53 can be formed of an appropriate conductor (for example, copper or the like).

The conductor pattern 51 is disposed at a position close to the end surface 3a and close to the side surface 3e. The conductor pattern 52 includes a first pattern portion 52A and a second pattern portion 52B. The first pattern portion 52A and the second pattern portion 52B may be integrally formed. The first pattern portion 52A is disposed at a position close to the end surface 3b and close to the side surface 3e. The second pattern portion 52B is disposed at a position close to the end surface 3b.

The conductor pattern 53 includes a first pattern portion 53A, a second pattern portion 53B, and a third pattern portion 53C. The first pattern portion 53A, the second pattern portion 53B, and the third pattern portion 53C may be integrally formed. The first pattern portion 53A is disposed at a position close to the end surface 3a and close to the side surface 3f. The second pattern portion 53B is disposed at a position close to the end surface 3b and close to the side surface 3f. The third pattern portion 53C has a plurality of bent portions. One end of the third pattern portion 53C is connected to the first pattern portion 53A. The other end of the third pattern portion 53C is connected to the second pattern portion 53B.

As illustrated in FIG. 11C, the conductor layer 45 includes a conductor pattern 54, a conductor pattern 55, a conductor pattern 56, a conductor pattern 57, a conductor pattern 58, a conductor pattern 59, and a conductor pattern 60. The conductor pattern 54, the conductor pattern 55, the conductor pattern 56, the conductor pattern 57, the conductor pattern 58, the conductor pattern 59, and the conductor pattern 60 can be formed of an appropriate conductor (for example, copper or the like).

The conductor pattern 54 is disposed at a position close to the end surface 3a and close to the side surface 3e. The conductor pattern 54 electrically connects the conductor pattern 51 of the conductor layer 44 and a conductor pattern 62 (see FIG. 11E) of the conductor layer 47 (see FIG. 11E). The conductor pattern 55 is disposed at a position close to the end surface 3b and close to the side surface 3e. The conductor pattern 55 electrically connects the conductor pattern 52 of the conductor layer 44 and a conductor pattern 63 (see FIG. 11E) of the conductor layer 47.

The conductor pattern 56 is disposed at a position close to the end surface 3a and close to the side surface 3f. The conductor pattern 56 electrically connects the conductor pattern 53 of the conductor layer 44 and a conductor pattern 64 (see FIG. 11E) of the conductor layer 47. The conductor pattern 57 is disposed at a position close to the end surface 3b and close to the side surface 3f. The conductor pattern 57 electrically connects the conductor pattern 53 of the conductor layer 44 and a conductor pattern 65 (see FIG. 11E) of the conductor layer 47.

The conductor pattern 58 electrically connects the resistance pattern 50 of the conductor layer 43 and the conductor pattern 63 (see FIG. 11E) of the conductor layer 47. The conductor pattern 59 electrically connects the resistance pattern 50 of the conductor layer 43 and the conductor pattern 62 (see FIG. 11E) of the conductor layer 47. The conductor pattern 59 is disposed at a position facing the conductor pattern 58 in the third direction D3 in plan view. The conductor pattern 60 electrically connects the conductor pattern 52 of the conductor layer 44 and a conductor pattern 61 (see FIG. 11D) of the conductor layer 46.

As illustrated in FIG. 11D, the conductor layer 46 includes the conductor pattern 61. The conductor pattern 61 can be formed of an appropriate conductor (for example, copper or the like). The conductor pattern 61 is a conductor (intermediate conductor) that is stacked on the conductor pattern 52 formed in the conductor layer 44 with the dielectric film 19 (see FIG. 6) interposed therebetween and constitutes an upper electrode of the capacitor C.

As illustrated in FIG. 11E, the conductor layer 47 includes a conductor pattern 62, a conductor pattern 63, a conductor pattern 64, and a conductor pattern 65. The conductor pattern 62, the conductor pattern 63, the conductor pattern 64, and the conductor pattern 65 can be formed of an appropriate conductor (for example, copper or the like).

The conductor pattern 62 includes a first pattern portion 62A, a second pattern portion 62B, a third pattern portion 62C, a fourth pattern portion 62D, and a fifth pattern portion 62E. The first pattern portion 62A, the second pattern portion 62B, the third pattern portion 62C, and the fourth pattern portion 62D may be integrally formed. The first pattern portion 62A is disposed at a position close to the end surface 3a and close to the side surface 3e. The second pattern portion 62B extends linearly along the third direction D3. One end of the second pattern portion 62B is connected to the first pattern portion 62A. The other end of the second pattern portion 62B is connected to the third pattern portion 62C.

The third pattern portion 62C has a plurality of bent portions. The third pattern portion 63C has the same shape as the third pattern portion 52C of the conductor pattern 52. One end of the third pattern portion 62C is connected to the second pattern portion 62B. The other end of the third pattern portion 62C is connected to the fourth pattern portion 62D. The fourth pattern portion 62D is disposed at a position close to the end surface 3b.

The conductor pattern 63 is disposed at a position close to the end surface 3b and close to the side surface 3e. The conductor pattern 64 is disposed at a position close to the end surface 3a and close to the side surface 3f. The conductor pattern 65 is disposed at a position close to the end surface 3b and close to the side surface 3f.

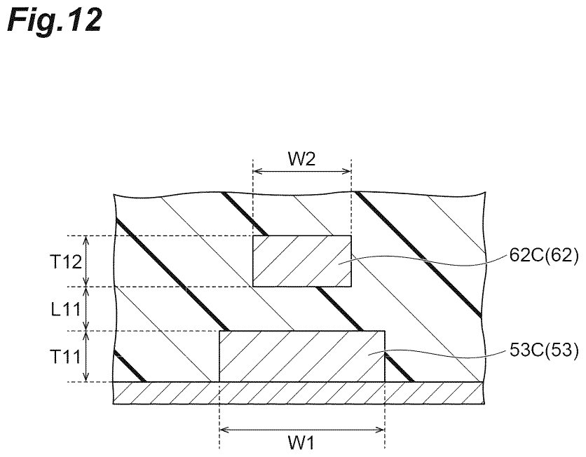

FIG. 12 is a diagram illustrating a cross-sectional configuration of a part of the electronic component 1A including conductor patterns. As illustrated in FIG. 12, the third pattern portion 53C of the conductor pattern 53 and the third pattern portion 62C of the conductor pattern 62 are disposed at positions facing each other in the second direction D2. That is, the third pattern portion 53C of the conductor pattern 53 and the third pattern portion 62C of the conductor pattern 62 are disposed at positions overlapping each other in plan view.

A distance L11 between the third pattern portion 53C of the conductor pattern 53 and the third pattern portion 62C of the conductor pattern 62 in the second direction D2 can be, for example, 5 μm. A thickness T11 of the third pattern portion 53C of the conductor pattern 53 and a thickness T12 of the third pattern portion 62C of the conductor pattern 62 can be, for example, 5 μm. The distance L11 and the thicknesses T11 and T12 can be the same (L11=T11, T12).

A width W1 of the third pattern portion 53C of the conductor pattern 53 is wider than a width W2 of the third pattern portion 62C of the conductor pattern 62 (W1>W2). In plan view, the entire third pattern portion 62C of the conductor pattern 62 overlaps the third pattern portion 53C of the conductor pattern 53. That is, in plan view, the third pattern portion 62C of the conductor pattern 62 is covered with the third pattern portion 53C of the conductor pattern 53. In other words, the third pattern portion 53C of the conductor pattern 53 does not protrude outward from the third pattern portion 62C of the conductor pattern 62 in plan view.

As illustrated in FIG. 11F, the conductor layer 48 includes a conductor pattern 66, a conductor pattern 67, a conductor pattern 68, and a conductor pattern 69. The conductor pattern 66, the conductor pattern 67, the conductor pattern 68, and the conductor pattern 69 can be formed of an appropriate conductor (for example, copper or the like).

The conductor pattern 66 is disposed at a position close to the end surface 3a and close to the side surface 3e. The conductor pattern 66 electrically connects the conductor pattern 62 of the conductor layer 47 and a first terminal electrode 4 of the third conductor layer 42 (see FIG. 11G). The conductor pattern 67 is disposed at a position close to the end surface 3b and close to the side surface 3e. The conductor pattern 67 electrically connects the conductor pattern 63 of the conductor layer 47 and a second terminal electrode 5 (see FIG. 11G) of the third conductor layer 12.

The conductor pattern 68 is disposed at a position close to the end surface 3a and close to the side surface 3f. The conductor pattern 68 electrically connects the conductor pattern 64 of the conductor layer 47 and a third terminal electrode 6 (see FIG. 11G) of the third conductor layer 12. The conductor pattern 69 is disposed at a position close to the end surface 3b and close to the side surface 3f. The conductor pattern 69 electrically connects the conductor pattern 65 of the conductor layer 47 and a fourth terminal electrode 7 (see FIG. 11G) of the third conductor layer 12.

As illustrated in FIG. 11G, the third conductor layer 42 includes the first terminal electrode 4, the second terminal electrode 5, the third terminal electrode 6, and the fourth terminal electrode 7. The third conductor layer 12 is a terminal layer.

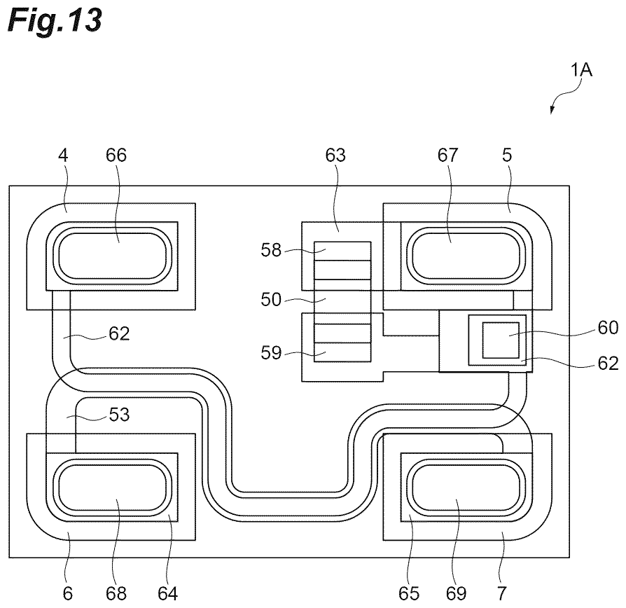

FIG. 13 is a diagram illustrating conductor patterns included in the electronic component 1A. As illustrated in FIG. 13, the resistance pattern 50 and the capacitor pattern (the second pattern portion 52B of the conductor pattern 52, and the conductor pattern 61) are disposed at positions close to the second terminal electrode 5 (ground electrode).

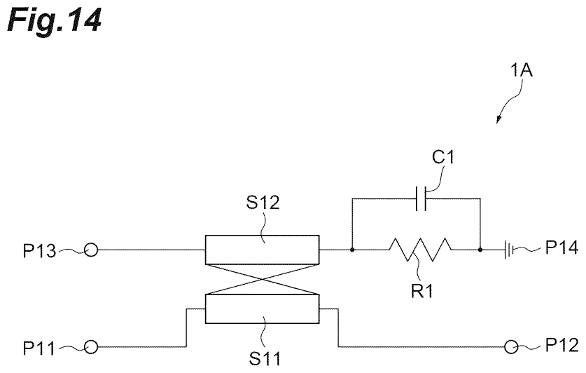

FIG. 14 is an equivalent circuit diagram of the electronic component 1A. As illustrated in FIG. 14, the electronic component 1A includes an input port P11, an output port P12, a coupling port P13, a ground port P41, a first line S11, and a second line S12.

The input port P11 is constituted by the third terminal electrode 6. The output port P12 is constituted by the fourth terminal electrode 7. The coupling port P13 is constituted by the first terminal electrode 4. The ground port P14 is constituted by the second terminal electrode 5.

The first line S11 connects the input port P11 and the output port P12. The first line S11 is constituted by the third pattern portion 53C of the conductor pattern 53. The second line S12 electrically connects the coupling port P13 and the ground port P14. The second line S12 is constituted by the third pattern portion 62C of the conductor pattern 62. The second line S12 includes a resistor R1 and a capacitor C1.

The first line S11 and the second line S12 are electromagnetically coupled. Specifically, the third pattern portion 53C of the conductor pattern 53 and the third pattern portion 62C of the conductor pattern 62 are electromagnetically coupled.

The resistor R1 is constituted by the resistance pattern 50. The resistor R1 is a termination resistor. The resistor R1 is connected between the second line S12 and the ground port P14. The resistor R1 is, for example, smaller than 50Ω. The capacitor C1 is constituted by the conductor pattern 61 and the fourth pattern portion 62D of the conductor pattern 62. The capacitor C1 is connected between the second line S12 and the ground port P14. The resistor R1 and the capacitor C1 are electrically connected in parallel.

As described above, in the electronic component 1A according to the present embodiment, the first line S11 and the second line S12 are magnetically coupled. As a result, magnetic coupling can be secured in the electronic component 1A. In the electronic component 1A, in the second line S12, the resistor R1 (termination resistor) provided on the end portion side connected to the second terminal electrode 5 (ground electrode) in the second line S12, and the capacitor C1 are provided. The resistor R1 and the capacitor C1 are electrically connected in parallel in the second line S12. As described above, in the electronic component 1A, an attenuation pole can be formed in a relationship (graph) between a frequency and isolation by electrically connecting the resistor R1 and the capacitor C1 in parallel in the second line S12. Thus, it is possible to adjust isolation in the electronic component 1A. Therefore, in the electronic component 1A, it is possible to balance (adjust) magnetic coupling and isolation.

In the electronic component 1A according to the present embodiment, the first line S11 and the second line S12 have portions overlapping each other (the third pattern portion 53C of the conductor pattern 53 and the third pattern portion 62C of the conductor pattern 62) when viewed from the stacking direction of the insulator 3 (the second direction D2), and are magnetically coupled at the portions. In this configuration, it is possible to secure magnetic coupling between the first line S11 and the second line S12.

In the electronic component 1A according to the present embodiment, the first line S11 is wider than the second line S12 in the portion where the first line S11 and the second line S12 overlap each other when viewed from the second direction D2. In this configuration, even when a deviation occurs in stacking between the first conductor layer 40 and the second conductor layer 41, the first line S11 and the second line S12 overlap each other in the stacking direction. Therefore, in the electronic component 1A, even when a deviation occurs in stacking between the first conductor layer 40 and the second conductor layer 41, magnetic coupling between the first line S11 and the second line S12 can be secured.

In the electronic component 1A according to the present embodiment, the second line S12 is covered with the first line S11 in the portion where the first line S11 and the second line S12 overlap each other when viewed from the second direction D2. In this configuration, the second line S12 does not protrude (project) from the first line S11. Therefore, magnetic coupling between the first line S11 and the second line S12 can be secured more reliably.

Although the embodiments of the present disclosure have been described above, the present disclosure is not necessarily limited to the above-described embodiments, and various modifications can be made without departing from the gist thereof.

In the above embodiment, in the electronic component 1, a mode in which the first conductor layer 10 has the third pattern portion 21C of the conductor pattern 21 and the third pattern portion 23C of the conductor pattern 23, and the second conductor layer 11 has the third pattern portion 33C of the conductor pattern 33 and the third pattern portion 35C of the conductor pattern 35 has been described as an example. However, for example, only the first conductor layer 10 may have the third pattern portion 21C of the conductor pattern 21 and the third pattern portion 23C of the conductor pattern 23. That is, the second conductor layer 11 may not have the third pattern portion 33C of the conductor pattern 33 and the third pattern portion 35C of the conductor pattern 35.

In the above embodiment, a mode in which the width W1 of the third pattern portion 53C of the conductor pattern 53 is wider than the width W2 of the third pattern portion 62C of the conductor pattern 62 (W1>W2) has been described as an example. However, the width W1 of the third pattern portion 53C of the conductor pattern 53 may be equal to the width W2 of the third pattern portion 62C of the conductor pattern 62. The width W2 of the third pattern portion 62C of the conductor pattern 62 may be larger than the width W1 of the third pattern portion 53C of the conductor pattern 53.

What is claimed is:

1. An electronic component comprising:
an element body formed by stacking a plurality of insulator layers and a plurality of conductor layers; and
an input electrode, an output electrode, a detection electrode, and a ground electrode disposed on a mounting surface of the element body, wherein
the plurality of conductor layers include a first conductor layer and a second conductor layer,
a first line electrically connecting the input electrode and the output electrode and a second line electrically connecting the detection electrode and the ground electrode are configured in the first conductor layer and the second conductor layer,
the second line includes a resistor provided on an end portion side connected to the ground electrode in the second line and a capacitor,
the resistor and the capacitor are electrically connected in parallel, and
the first line and the second line are magnetically coupled.

2. The electronic component according to claim 1, wherein the first line and the second line have portions extending side by side when viewed from a stacking direction of the element body, and are magnetically coupled at the portions.

3. The electronic component according to claim 2, wherein the first line and the second line do not overlap each other when viewed from the stacking direction.

4. The electronic component according to claim 1, wherein the first line and the second line have portions overlapping each other when viewed from a stacking direction of the element body, and are magnetically coupled at the portions.

5. The electronic component according to claim 4, wherein one of the first line and the second line is wider than the other of the first line and the second line in the first line and the second line when viewed from the stacking direction.

6. The electronic component according to claim 5, wherein one of the first line and the second line is covered with the other of the first line and the second line in a portion where the first line and the second line overlap each other when viewed from the stacking direction.

7. The electronic component according to claim 1, wherein the resistor and the capacitor are disposed at positions closer to the ground electrode than the detection electrode.

8. The electronic component according to claim 1, wherein the resistor is disposed on an inner side than the capacitor in the element body when viewed from a stacking direction of the element body.
